(19) United States
(12) Patent Application Publication
(10) Pub. No.: US 2009/0001101 A1
(43) Pub. Date: Jan. 1, 2009

(54) Powder Dispenser

(75) Inventors: Erin Zahradka, Broomfield, CO (US); Robert J. Prince, Longmont, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ezstella, LLC, Broomfield, CO (US)

(21) Appl. No.: 12/164,994

(22) Filed: Jun. 30, 2008

Related U.S. Application Data
(60) Provisional application No. 60/946,786, filed on Jun. 28, 2007.

(51) Int. Cl. G01F 11/00; G01F 11/14; B65D 88/54

(52) U.S. Cl. 222/228; 141/340; 222/243; 222/308; 222/361

(57) ABSTRACT

A powder dispensing device is disclosed according to various embodiments. The powder dispenser includes a gravity bin configured to contain powder with a top opening and a smaller bottom opening. A housing coupled with and located beneath the gravity bin includes a top portion with a dosage portal. The dosage portal of the housing and the bottom opening of the gravity bin are substantially vertically misaligned. A slider that includes a dosage chamber with an opening in both the top surface and the bottom surface is included. The slider is configured to move between a first position and a second position. In the first position the dosage chamber is substantially aligned with the dosage portal of the housing and in the second position the dosage chamber is substantially aligned with the bottom opening of the gravity bin. An actuator moves the slider between the first position and the second position.

### CROSS-REFERENCES TO RELATED APPLICATIONS

This application is a non-provisional, and claims the benefit, of U.S. Provisional Application No. 60/946,786, filed Jun. 28, 2007, entitled “Baby Formula Dispenser,” the entirety of which is herein incorporated by reference for all purposes.

### BACKGROUND OF THE INVENTION

There are 133 million births each year, 247 births every minute, 4 babies born every second. While a percentage of mothers breast-feed their babies, 85% of mothers bottle-feed their babies within the first year of their life, for at least one year. Many mothers use a powdered baby formula within these bottles whether using infant formula or toddler formula when transitioning to cow's milk.

Various other drink mixes are available in a powdered form. Such mixes can be dispensed and mixed with a fluid, such as water, to create the drink. These powdered drinks can include but are not limited to chocolate milk mixes, punches, sports drinks, and even nutritional specific drinks for the elderly, diabetic, etc.

It can be a challenge to dispense and mix baby formula quickly, consistently measured, and easily without making a mess. The challenge can be magnified while holding an unhappy and/or hungry child. Often powder is provided in a large container and the proper dose is measured with a provided plastic cup or scoop. Accuracy and consistency can be a challenge for both baby formula and drink mixes, especially when using one hand while simultaneously tending to child with the other. Powdered drink mix and baby formula containers are often unsightly and either require space on the counter top in plain view, or to be hidden in a cupboard and taken out with each feeding, which again can be difficult when hungry child needs to eat quickly. There is a general need for a convenient and stylish powder dispenser which dispenses more consistently with each use than if you were to scoop the powder yourself.

### SUMMARY OF THE INVENTION

A powder dispensing device is provided according to one embodiment. The powder dispensing device according to this embodiment includes a funnel shaped gravity bin, a housing, a slider and an actuator. The gravity bin includes top and smaller bottom openings, and may be configured to contain powder. The housing may be coupled with and located beneath the gravity bin. The housing may include a top portion with a dosage portal. The dosage portal and the bottom opening of the gravity bin may be substantially vertically misaligned. The slider includes a top surface, a bottom surface, and a dosage chamber with an opening in both the top surface and the bottom surface. The slider may be configured to move between a first position and a second position. In the first position the dosage chamber is substantially aligned with the dosage portal of the housing and in the second position the dosage chamber is substantially aligned with the bottom opening of the gravity bin. The actuator may be configured to move the slider between the first position and the second position.

The actuator, in another embodiment, may comprise a manual lever that moves the slider between the first position and the second position when the lever is moved from a first lever point to a second lever point. The powder dispensing device may also include a powder agitator coupled with the slider. The powder agitator may extend into the gravity bin and may include a spring. In another embodiment the dosage chamber may include a moveable wall coupled with a screw; wherein the volume of the dosage chamber varies based on the position of the moveable wall. In another embodiment, the housing may include a bleed hole that is substantially vertically aligned with bottom opening of the gravity bin. In yet another embodiment, portions of the powder dispensing device comprise bisphenol A (BPA) free plastic. BPA is one example of a safe and chemical free food grade plastic. Other food grade plastics may be used, for example, food grade HDPE, plastics with polycarbonate, polyester and/or polyethylene, and/or PVC free plastics.

A powder dispensing device is provided according to another embodiment. The powder dispensing device may include containing means, dispensing means, agitating means, a housing and actuating means. The containing means for containing a powder may include a first opening for receiving the powder and a second opening for dispensing a dose of the powder. The housing may be coupled with and located beneath the containing means and/or may include a top portion with a dosage portal. The dosage portal and the second opening of the containing means may be vertically powder dispensing device misaligned. The dispensing means may be configured for receiving a dose of powder from the containing means through the second opening and for dispensing the dose of powder through the dosage portal of the housing and into a specific container, for example, a bottle for baby formula. The actuating means may be configured for moving the dispensing means between receiving the dose of powder from the containing means and dispensing the dose of powder through the dosage portal of the housing. The powder dispensing device may also comprise agitating means for agitating powder held within the containing means to prevent “bridging” or clumping of the powder.

Another powder dispensing device is provided according to various embodiments. A funnel shaped gravity bin is included with a top and a smaller bottom opening. The gravity bin is configured to contain powder. The housing may be coupled with and located beneath the gravity bin. The housing may also include a top portion with a dosage portal that is substantially vertically misaligned with the bottom opening of the gravity bin. A slider may also be included. The slider may comprise a top surface, a bottom surface, and a dosage chamber with an opening in both the top surface and the bottom surface. The slider may be configured to move between a first position and a second position; in the first position the dosage chamber is substantially aligned with the dosage portal of the housing and in the second position the dosage chamber is substantially aligned with the bottom opening of the gravity bin. A powder agitator may coupled with the slider. In some embodiments, the powder agitator may extend into the gravity bin through the bottom opening of the gravity bin or may comprise a hammer. A manual lever that moves the slider between the first position and the second position when the lever is moved from a first lever point to a second lever point may also be included.

A powdered baby formula dispenser is disclosed according to one embodiment of the invention. The baby formula dispenser may dispense pre-measured formula with a single action. The baby formula dispenser may streamline the process of preparing bottle of formula. The baby formula dispenser may help a parent save time, ensure accuracy and consistency in mixing proportions, provide a mess-free dispenser, and provide an aesthetically pleasing storage container for formula. The baby formula dispenser may be very safe. The baby formula dispenser may include no hazardous parts, and may be easy to wipe clean and may be dishwasher safe for the gravity bin on top rack of dishwasher.

### BRIEF DESCRIPTION OF THE DRAWINGS

FIG. 1A shows a side view of a powder dispenser in a first position according to one embodiment.

FIG. 1B shows a side view of a powder dispenser in a second position according to one embodiment.

FIG. 1C shows a side view of a powder dispenser in a second position and with a hammer agitator according to one embodiment.

FIG. 1D shows a side view of a powder dispenser in a second position and with a bar type agitator according to one embodiment.

FIG. 2 shows a front view of a powder dispenser according to one embodiment.

FIG. 3 shows an isometric view of a powder dispenser according to one embodiment.

FIG. 4 shows an side view of a powder dispenser according to one embodiment.

FIG. 5 shows another isometric view of a powder dispenser according to one embodiment.

FIGS. 6A and 6B show side and top views of a gravity bin according to one embodiment.

FIGS. 7A and 7B show top views of a slider and a dosage chamber according to one embodiment.

FIG. 8 shows an isometric view of a powder dispenser without a gravity bin enclosure according to one embodiment.

FIG. 9 shows an isometric bottom view of a powder dispenser without a gravity bin enclosure according to one embodiment.

FIG. 10 shows an isometric top view of a powder dispenser without a gravity bin enclosure according to one embodiment.

FIG. 11 shows a side view of a powder dispenser without a gravity bin enclosure according to one embodiment.

FIG. 12 shows a powder dispenser with a shaped agitation bar according to one embodiment.

FIG. 13 shows portions of the slider, handle and actuating mechanisms of a powder dispenser according to one embodiment.

FIG. 14 shows another top view of a powder dispenser according to one embodiment.

In the appended figures, similar components and/or features may have the same reference label. Where the reference label is used in the specification, the description is applicable to any one of the similar components having the same reference label.

### DETAILED DESCRIPTION OF THE INVENTION

Various embodiments disclosed herein provide for powder dispensing in set amounts. The powders, for example, may be a powdered drink mix or baby formula. In some embodiments, the dispensers described herein generally provide the proper action to grab, shear and drop powder into a receptacle. The shear action may include a linear or rotating slider. In one embodiment, a slideable mechanism with a dosage chamber is used to grab the requisite volume of powder. As the slideable mechanism is moved into place, gravity pulls powder into the dosage chamber from a powder reservoir. After which, the slideable mechanism is released and a dose of powder is sheared from the powder reservoir. As the slideable mechanism moves into a second position, the powder held within the dosage chamber into a waiting bottle, for example. In another embodiment, the dispenser may include an agitator that provides mix and/or agitation within the powder reservoir in order to provide powder with out air pockets and/or clumps.

The term “powder” is used throughout the specification to include a material in defined by fine, loose particles. The term may also include materials with a dust consistency, granular materials, granulate, milled materials, flakey materials, materials with a sand-like consistency, crumbs, puffs, grains, nuggets, seeds, chips, morsels, kernels, etc.

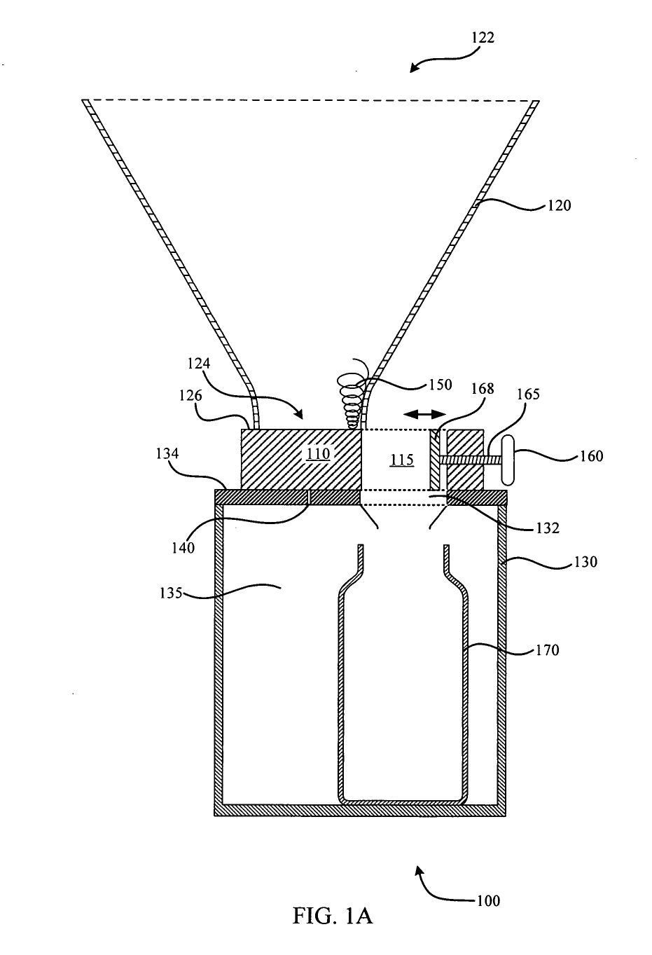

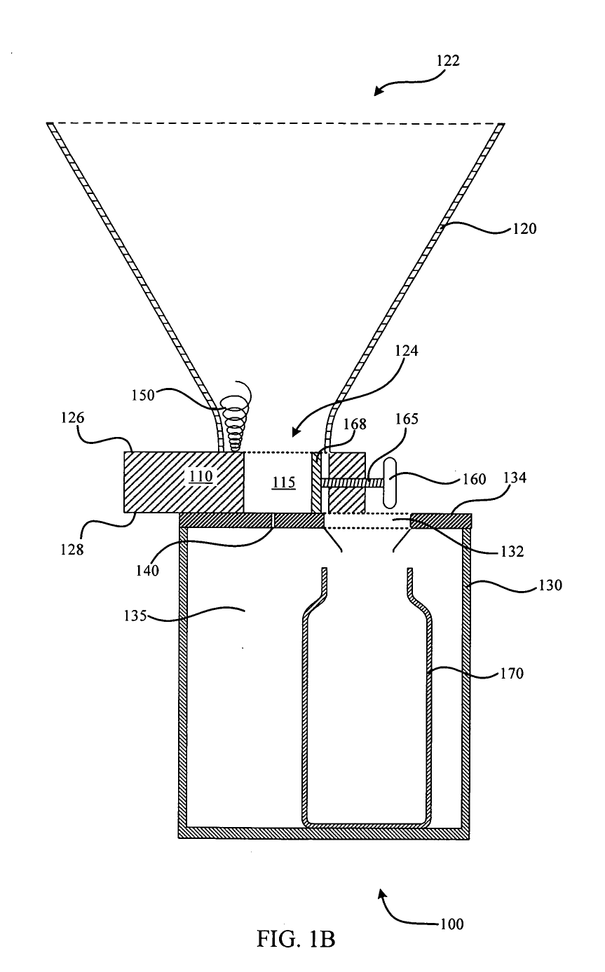

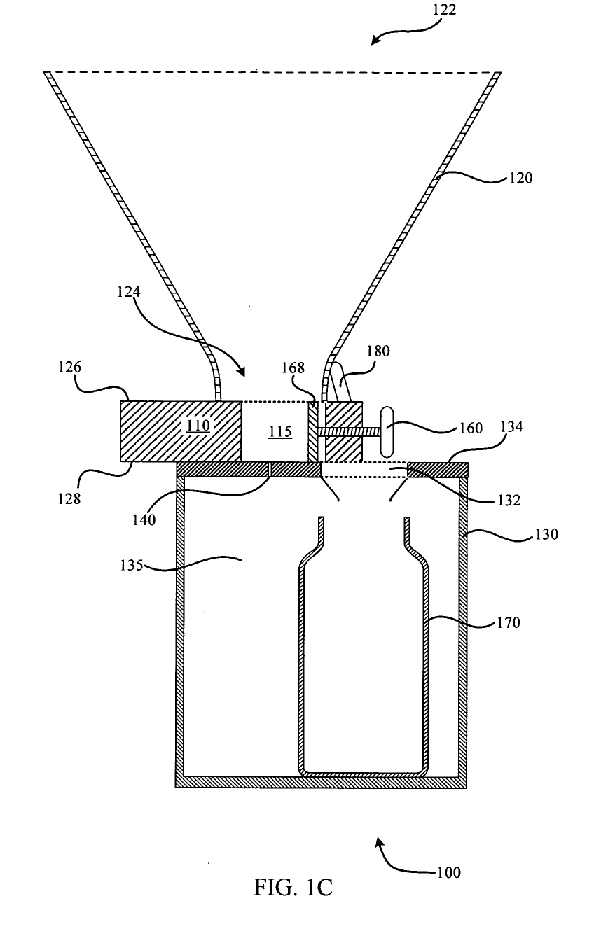

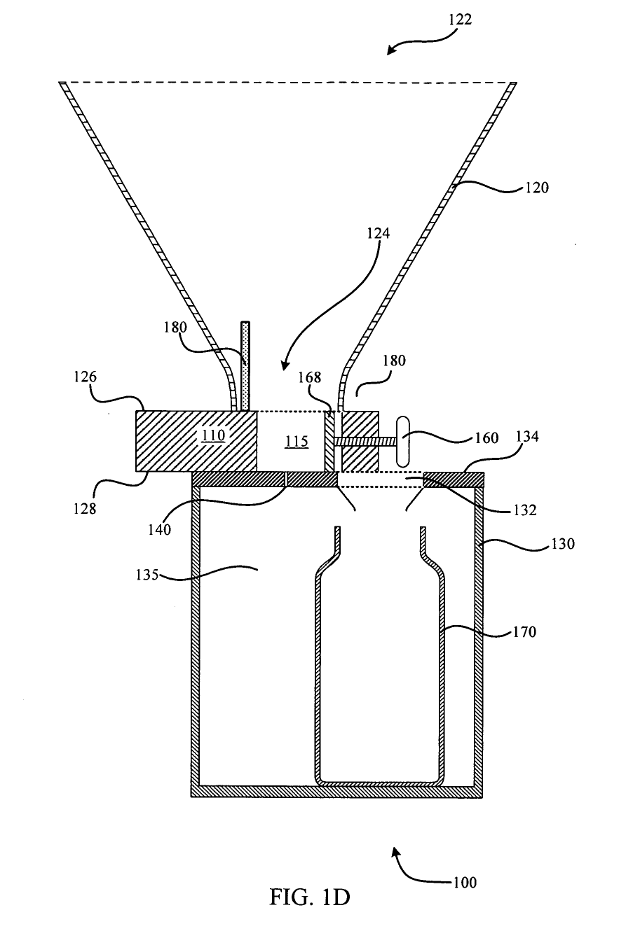

FIGS. 1A and 1B show a side view of a powder dispenser 100 according to one embodiment. Generally speaking, the powder dispenser 100, according to this embodiment, includes a gravity bin 120, a slider 110 and a housing 130. The powder dispenser 100 takes advantage of gravitation to move a dose of powder from the gravity bin 120 into a receptacle 170 within the housing 130. The gravity bin 120 includes a top opening 122 and a bottom opening 124. The gravity bin 120 is generally funnel shaped, that is, the gravity bin 120 includes angled walls. The top opening 122 may be used to fill the gravity bin 120 with powder. A lid may be placed on top of the gravity bin 120. Powder held within the gravity bin 120 is dispensed through the bottom opening 124.

The housing 130 includes a receptacle chamber 135 configured to house a receptacle 170 and a top surface 134. The top surface 134 may also, in some embodiments, include a bleed hole 140 and a dosage portal 132. The dosage portal is vertically misaligned with the bottom opening 124 of the gravity bin 120 as shown in the figure. Powder may be dropped into the receptacle 170 through the dosage portal 132 using gravity. As will be discussed below, the slider 110, may receive powder from the gravity bin 120 and drop the powder into the receptacle through the dosage portal.

The slider 110, in some embodiments, includes a top surface 126, a bottom surface 128 and a dosage chamber 115. The dosage chamber 115 includes an opening in the top surface 126 and the bottom surface 128. The slider 110 is arranged to slide between two positions. The first position, as shown in FIG. 1A, aligns the dosage chamber 115 of the slider 110 with the dosage portal 132 of the housing 130. The second position, as shown in FIG. 1B, aligns the dosage chamber 115 of the slider 110 with the bottom opening 124 of the gravity bin 120. During operation, in one embodiment, the slider is in the first position. The slider 110 can be moved, for example, with an actuator, into the second position. In the second position, powder from within the gravity bin 120 may drop into the dosage chamber 115. The bottom of the dosage chamber 115 is sealed by the top surface 134 of the housing 130. The slider 110 may then move back into the first position, where the powder within the dosage chamber 115 drops through the dosage portal 132 and into a waiting receptacle 170.

In various embodiments, the slider 110 may also include an agitator 150. The agitator mixes and agitates the powder during movement of the slider 110 from the second position into the first position. Agitation may be necessary in some powders that have a tendency to clump and/or create air pockets. Such powders may require agitation in order to allow gravity to pull the powder from the gravity bin 120 into the dosage chamber 115. Agitation ma also help in providing the proper dosage. Various agitators may be used. For example, as shown a spring may be attached with the slider that extends into the gravity bin. During operation the spring moves through the powder breaking up clumps and/or air pockets. The spring may have a diameter that increases as shown. More than one agitator device may be included. The agitator, in some embodiments, may also be flexible, bendy and/or flimsy metal and/or plastic element. The agitator 150, in other embodiments, may also include an auger, a fin, a blade, and/or a fan. The agitator 150 may or may not be coupled with the slider.

In various embodiments, the top surface 134 of the housing 130 may include a bleed hole or holes 140. The bleed hole 140 may be designed to be smaller than an average powder grain size. The bleed hole 140 may allow for air to escape from the dosage chamber 115 as powder drops from the gravity chamber 120 into the dosage chamber 115. Multiple bleed holes may be included.

In various embodiments, the slider 110 may include a dosage chamber 115 with a fixed volume. Various volumes may be used depending on the type of powder being dispensed. In some embodiments, the dosage chamber 115 volume may be adjustable as shown in FIGS. 1A and 1B. The slider 110 may include an adjustable wall 168 within the dosage chamber 115. The adjustable wall 168 may be coupled with a screw 165 and a wheel 160, such that, as a user turns the wheel the adjustable wall moves in and out creating a smaller and/or larger dosage chamber 115. Thus, the dosage chamber 115 volume can be adjusted based on, for example, different types of powder and/or receptacles 170.

FIG. 1C shows the slider 110 in the second position with a hammer 180 impacting the gravity bin 120. The hammer 180 acts as an agitator when it impacts the side of the gravity bin 120. In other embodiments, a similar hammer repeatedly strikes the gravity bin 120 as the slider 110 moves from position to position. In yet another embodiment, multiple agitators may be employed to agitate powder within the gravity bin 120.

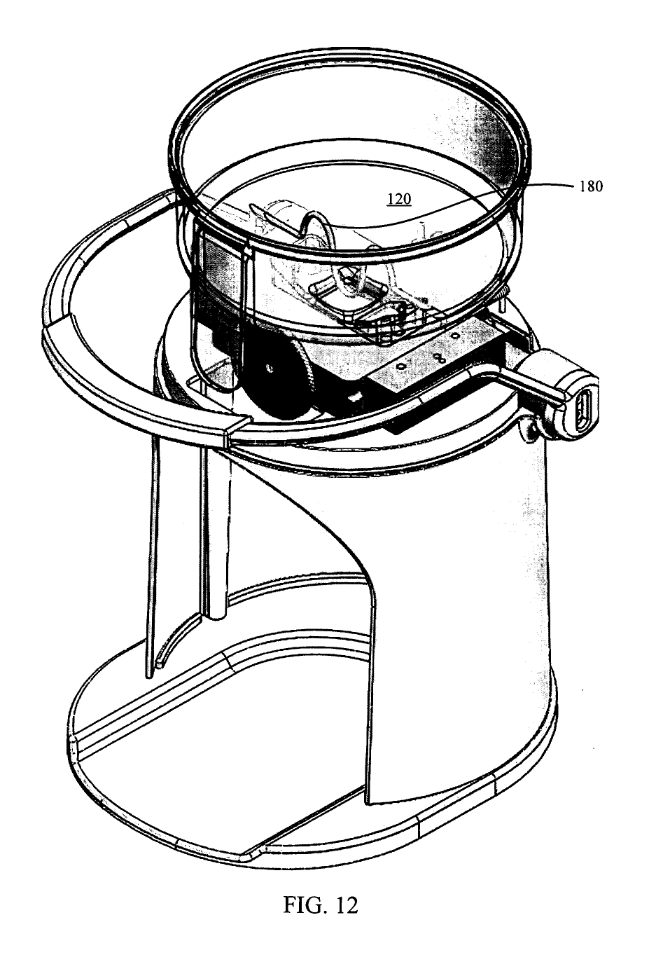

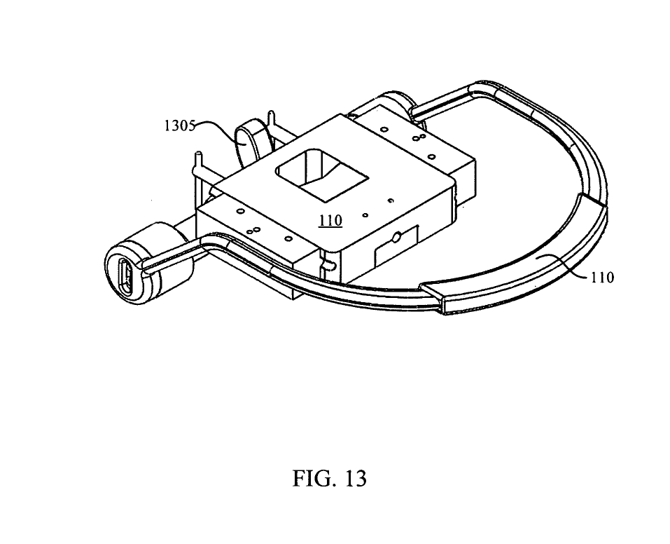

FIG. 1D shows a bar agitator 180 according to another embodiment. The bar may be shaped in any shape. The bar 180 may be coupled with the slider 110 and/or affixed within the gravity bin 120. The bar may be positioned within, above, near, around, the bottom opening 124 of the gravity bin 120. As shown in FIGS. 12 and 13 the bar agitator 180 may be in a curved shape. More than one bar may be included. Moreover, a bar or bars may be attached with the slider and another bar or bars may be attached with the gravity bin.

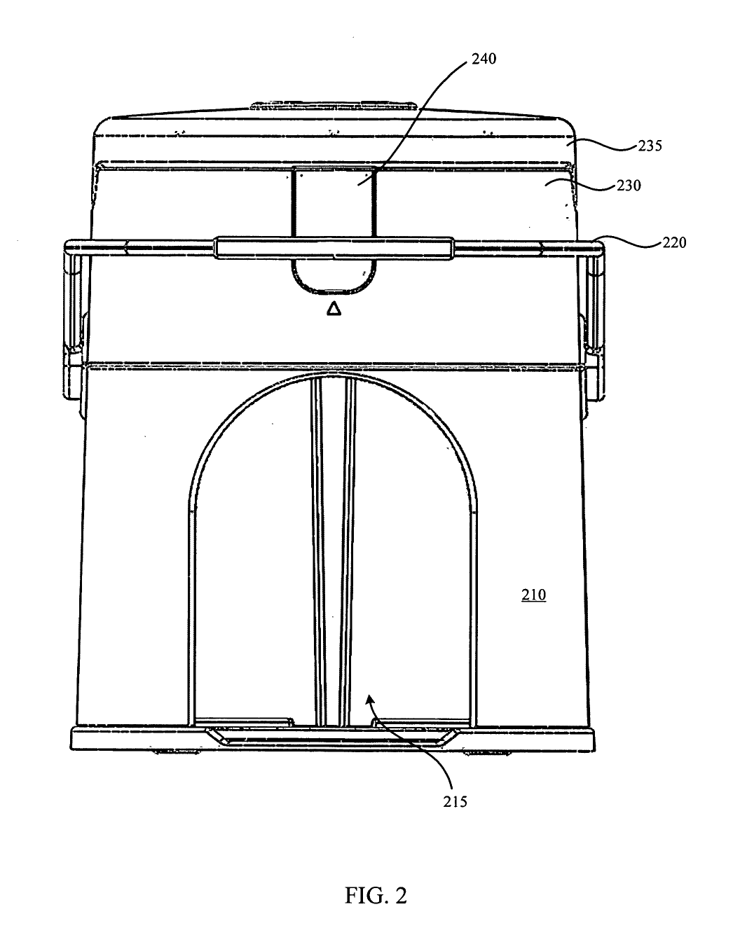

FIG. 2 shows a front view of a powder dispenser according to one embodiment. The powder dispenser includes a housing 210 with a receptacle chamber 215. The receptacle chamber 210 is configured to receive a bottle, jar, glass, cup etc. that is placed therein to receive a dose of powder. A gravity bin enclosure 230 is also included within which a gravity bin is placed for containing and providing powder. The gravity bin enclosure 230 in some embodiments, includes a window 240 within which the powder level may be monitored. The gravity bin enclosure 230 may also include a lid 235. A lever and/or handle 220 is also included. The handle 220 is coupled with a formula dispensing mechanism. For example, the handle when pressed downward may provide and/or induce a cam action on a slider for retrieving and dispensing powder.

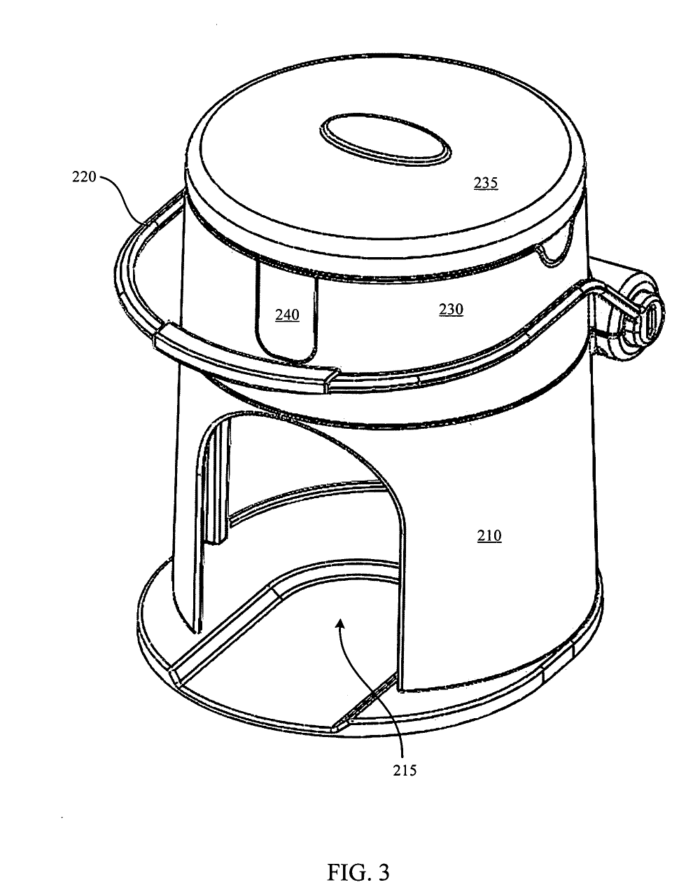

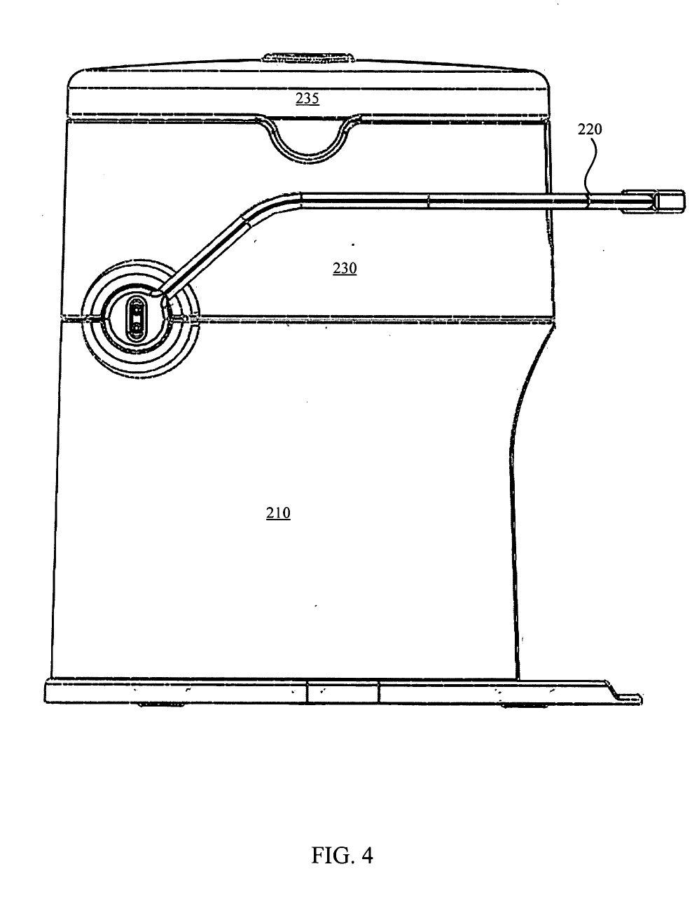

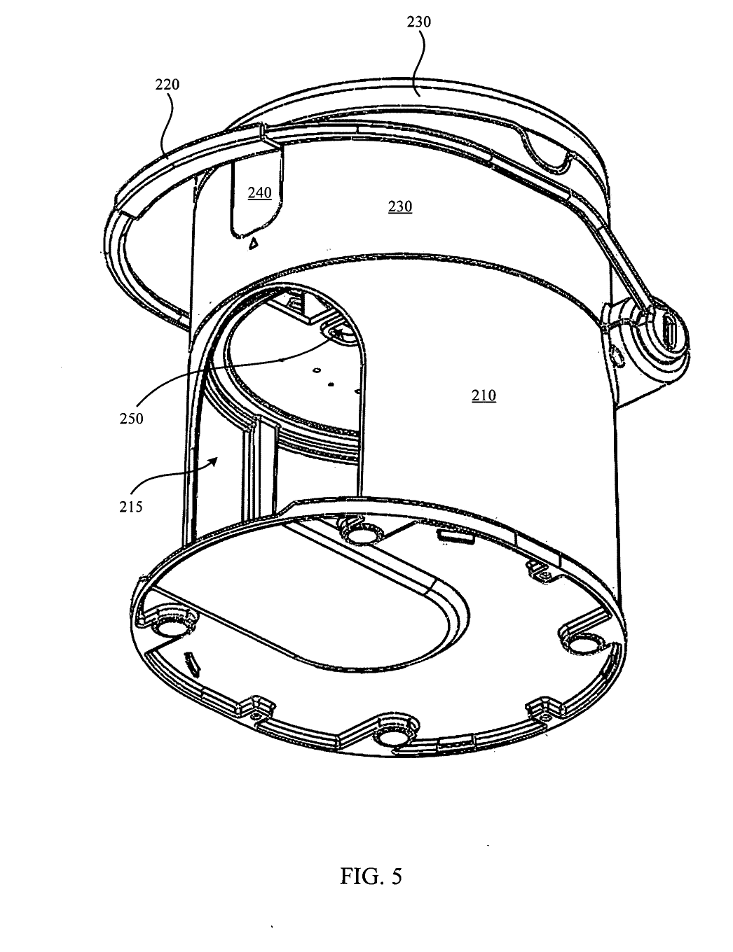

FIG. 3 shows an isometric view of a powder dispenser according to one embodiment. FIG. 4 shows an side view of a powder dispenser according to one embodiment. FIG. 5 shows another isometric view of a powder dispenser according to one embodiment. In this view the dosage portal 250 of the housing is shown.

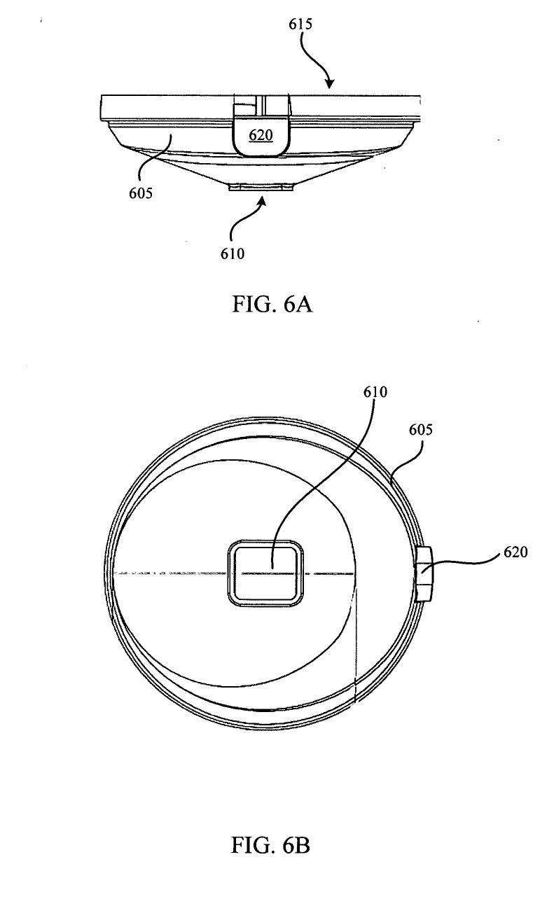

FIGS. 6A and 6B show side and top views of a gravity bin 605 according to one embodiment. The gravity bin 605 includes a top opening 615 and a bottom opening 610. A window 620 is also included so the contents of the gravity bin 605 can be monitored. The window may be coupled with the gravity bin enclosure 230 or may be part of the gravity bin enclosure 230 shown in previous figures. The funnel and/or sloped sides of the gravity bin provide funnel action on powder, funneling the powder toward the bottom opening 610.

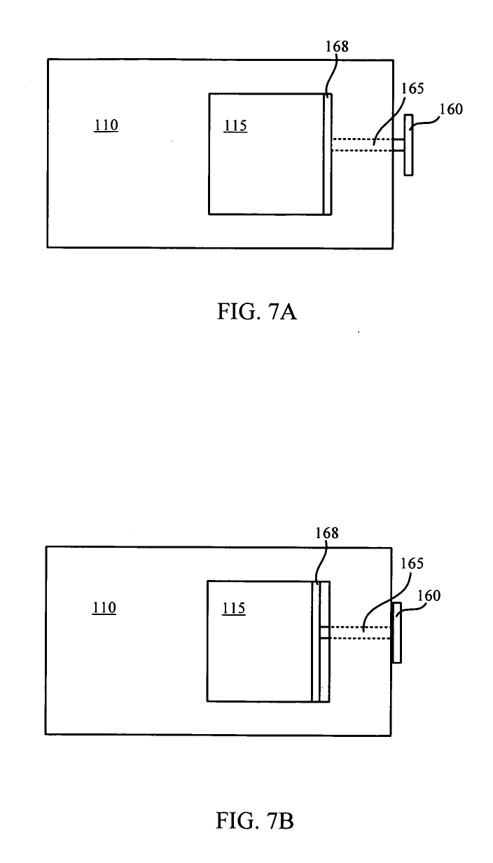

FIGS. 7A and 7B show top views of a slider 110 and a dosage chamber 115 according to one embodiment. The dosage chamber 115, in this embodiment, includes a moveable wall 168 coupled with a screw 165 and a thumb wheel 160. FIG. 6A shows the moveable wall 168 in a first position. FIG. 6B shows the moveable wall 168 in a second position, which decreases the volume of the dosage chamber 115. The moveable wall 168 may be moved to make fine dosage adjustments, for example, for more precise dosages, in one embodiment. In another embodiment, the moveable wall 168 may be moved to change from one dosage amount to another amount. For example, by moving the thumb wheel, the dosage may change from 8.5 grams to 8.9 grams. Thus, the thumb wheel may have five positions for each 8.5 grams, 8.6 grams, 8.7 grams, 8.8 grams, and 8.9 grams. These ranges, for example include the scoop sizes for some brands of baby formula and/or powdered drink mixes according to the measurement sizes on the back of their cans. In other embodiments the thumb wheel may measure volume rather than weight, for example from 18.2 ml to 22.2 ml of powder.

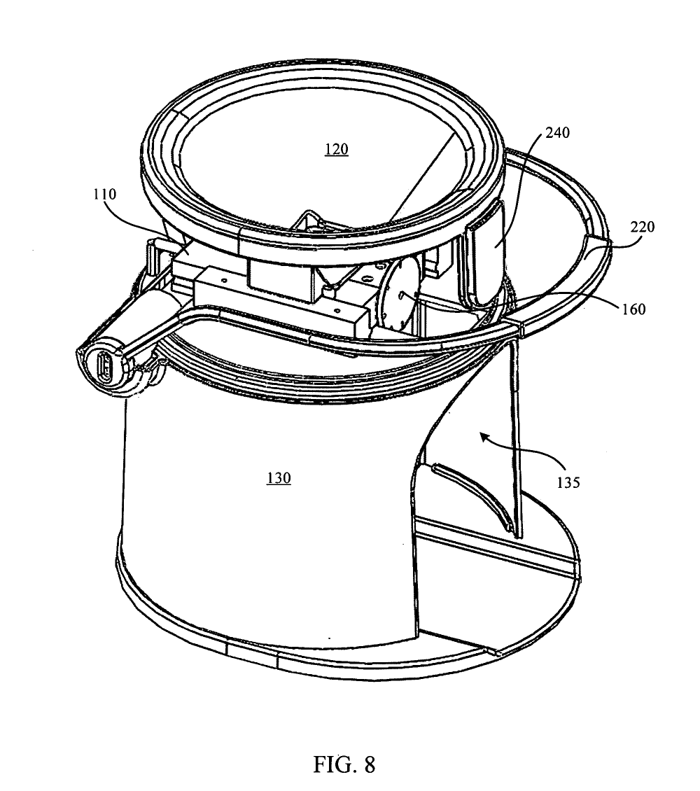

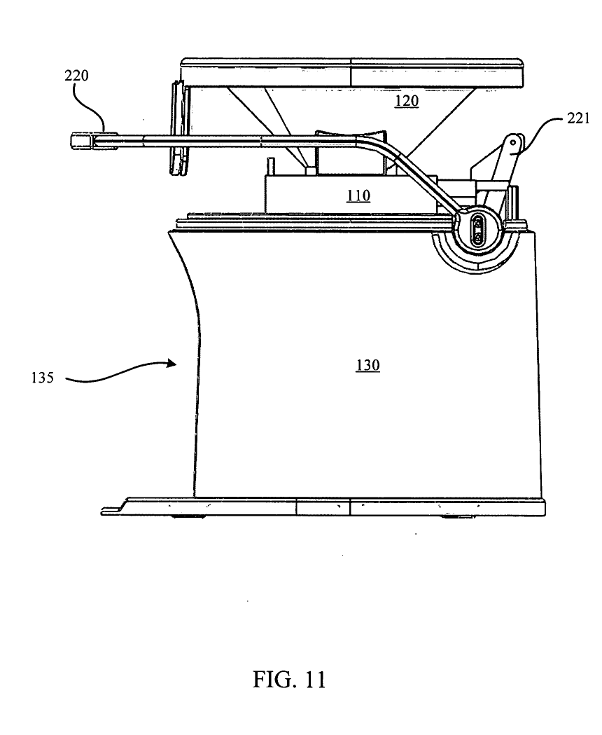

FIGS. 8-11 show various views of a powder dispenser without a gravity bin enclosure according to one embodiment. In this embodiment, a gravity bin 120 is shown with funneled walls. Moreover, a window 240 is shown coupled with the gravity bin 120. A linear slider 110 is also shown beneath the gravity bean and coupled with the handle 220. In these figures, as a user presses downward on the handle, the slider 110 moves back and forth with camming action to grab, slice, and drop powder from the gravity bin 120 into a receptacle housed within the receptacle chamber 135 of the housing 130. Various other actions may be used to grab, shear and drop powder from the gravity bin. Motorized actuators or rotators may be used according to one embodiment.

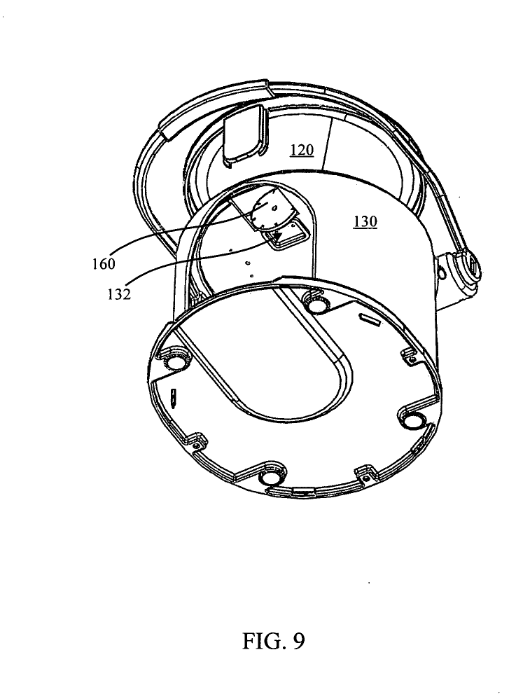

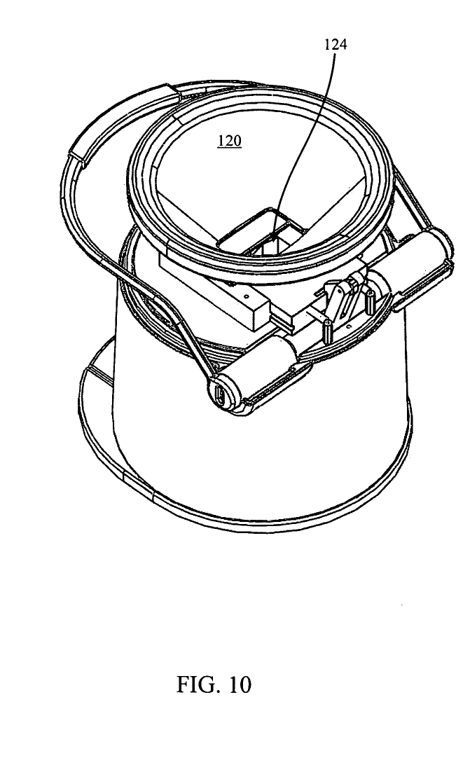

In FIG. 9, the dosage portal 132 is shown as seen through the receptacle chamber 135. The thumbwheel 160 is also shown. FIG. 10 shows the bottom opening 124 of the gravity chamber 120, according to another embodiment. In some embodiments, a slider, whether rotating or linearly actuating, presents a dosage chamber below the gravity bin to collect a dose of powder.

Various portions of the device may be constructed of non-corrosive materials according to one embodiment. In another embodiment, portions of the formula dispenser are constructed of plastic, stainless steel, aluminum, etc. For example, the gravity bin, slider and/or the housing may include a bisphenol A (BPA) free plastic. BPA is suspected of being hazardous to humans. Accordingly, any portion of the powder dispenser may include BPA free plastic, in another embodiment. In a specific embodiment, portions of the powder dispenser in contact with the powder include BPA free plastic.

FIG. 12 shows a powder dispenser with a shaped agitation bar 180 according to one embodiment. The shaped agitation bar 180 is placed within the gravity bin 120. In some embodiments, the shaped bar 180 is moved or rotated as the slider is actuated. In other embodiments, the shaped bar is stationary.

FIG. 13 shows portions of the slider 110, handle 220, and actuating mechanisms 1305 of a powder dispenser according to one embodiment. In some embodiments, the handle 220 may be moved from an upper position to a lower position. During this movement, the actuating mechanism 1305 is moved forward engaging the slider 110 and causing the slider to move from a first position to a second position. The slider 110 moves back to the first position as the handle is moved back up.

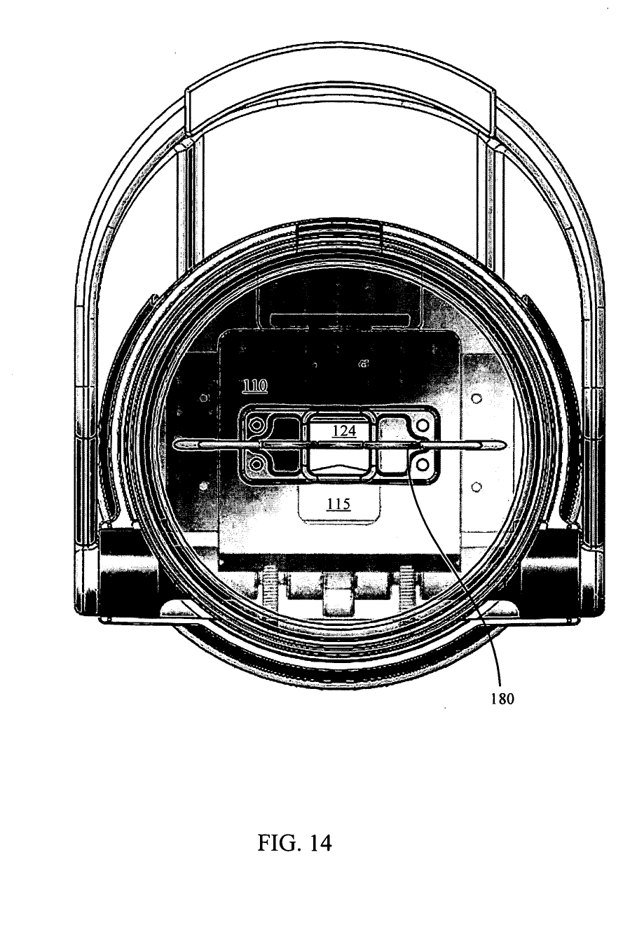

FIG. 14 shows another top view of a powder dispenser according to one embodiment. A bar shaped agitator 180 is shown within the gravity bin 220. Under the gravity bin 220, the slider 110 is visible in a first position. The dosage chamber 115 within the slider 110 is not aligned beneath the bottom opening 124 of the gravity bin 110.

A baby formula dispenser is also provided according to another embodiment. The baby formula dispenser may include an upper section and a lower section. The upper section may comprise a storage unit and/or a housing, and the lower section may include a dispensing mechanism. Accordingly, the upper section stores baby formula that is dispensed into a bottle thought the lower section. The storage unit may comprise of a housing chamber where the formula is contained and may be attached above the dispensing unit. The storage unit may be funnel shaped. In some embodiments, the storage unit or gravity bin may made with food grade, BPA free plastic. The upper section may also comprise a clear material such as glass, plastic, plexi-glass, lexan, or the like. The lower section includes a lever that engages a mechanisms within the lower section that dispenses measured units of formula. For example, a user may press the lever and 2 ounces of formula may be dispensed from the upper section through mechanisms in the lower section and into a bottle. The lever may include rubber padding.

The dispensing mechanism may include a number of gears, disks or cassettes. A top disk may be included that has a single hole that can contain a predetermined volume of formula, for example, 2.0 ounces. A middle disk or gear with a plurality of holes of the same size may be placed beneath the top disc. A bottom disk may also be provided with a hole misaligned from the top disk hole. Coupled with the lever is a ratchet arm. As the ratchet arm is pressed laterally, the center disk may rotate. The rotating action provides a new hole that may be filled with formula from the hole in the top disc. At the next ratchet the filled hole in the center disk is positioned above the hole in the bottom disk and the formula is dispensed into a waiting bottle beneath the bottom hole. Each push of the lever dispenses a set amount of formula. An agitator may be coupled with the top disk, for example, a blade, fan, spring, flexible rod, etc.

Other mechanisms may be used to dispense baby formula. A two disk system may be used. The two disk system may have a top ratcheting disk with a plurality of holes of a set volume. The bottom disk may be described as above. The holes of the top disk may fill with formula and dispense the formula through the hole on the bottom disc. The top portion may also include a stirring mechanism. The stirring mechanism may be coupled with the ratcheting disk or to other moving parts. When the lever is activated the stirring mechanism spins, breaking up clumps of formula and knocking out voids or cavities in the powder. The stirring mechanism may be a paddle or arm that simply spins with the ratcheting arm. The stirring mechanism may spin at a different rotational speed than the ratcheting arm. Other stirring mechanisms may be used.

The housing chamber, or top part, may be airtight and may include finger imprints for easy use with one hand so it may be filled with the formula. The top portion may be screwed into the bottom portion. For example, the top portion may also include a screw on lid. The top part, or gravity bin, may store up to 28 oz of powder. Various other amounts of powder may be stored within the top part.

The above description is meant to be exemplary only. Various other embodiments of the invention may be used without deviating from the spirit of the invention. Notably, other dispensing mechanisms, levers and combinations of the same may be employed to dispense pre-measured portions of baby formula.

Specific details are given in the above description to provide a thorough understanding of the embodiments. However, it is understood that the embodiments may be practiced without these specific details. For example, circuits, structures, and/or components may be shown in block diagrams in order not to obscure the embodiments in unnecessary detail. In other instances, well-known circuits, processes, algorithms, structures, components, and techniques may be shown without unnecessary detail in order to avoid obscuring the embodiments.

What is claimed is:

1. A powder dispensing device comprising:
a gravity bin including a top opening and a bottom opening, and configured to contain powder, wherein the top opening is larger than the bottom opening;
a housing coupled with and located beneath the gravity bin and including a top portion with a dosage portal, wherein the dosage portal and the bottom opening of the gravity bin are substantially vertically misaligned;
a slider including a top surface, a bottom surface, and a dosage chamber with an opening in both the top surface and the bottom surface, wherein the slider is configured to move between a first position and a second position, wherein in the first position the dosage chamber is substantially aligned with the dosage portal of the housing and in the second position the dosage chamber is substantially aligned with the bottom opening of the gravity bin; and
an actuator configured to move the slider between the first position and the second position.

2. The powder dispensing device according to claim 1, wherein the actuator comprises a manual lever that moves the slider between the first position and the second position when the lever is moved from a first lever point to a second lever point.

3. The powder dispensing device according to claim 1, wherein the gravity bin is funnel shaped.

4. The powder dispensing device according to claim 1, further comprising at least one powder agitator coupled with the slider and extending into the gravity bin.

5. The powder dispensing device according to claim 4, wherein the at least one powder agitator comprises a spring.

6. The powder dispensing device according to claim 4, wherein the at least one powder agitator comprises a shaped bar.

7. The powder dispensing device according to claim 1, wherein the dosage chamber includes a moveable wall coupled with a screw; wherein the volume of the dosage chamber varies based on the position of the moveable wall.

8. The powder dispensing device according to claim 1, wherein the housing includes a bleed hole that is substantially vertically aligned with bottom opening of the gravity bin.

9. The powder dispensing device according to claim 1, wherein portions of the powder dispenser comprise bisphenol A (BPA) free plastic.

10. A powder dispensing device comprising:
containing means for containing a powder, wherein the containing means includes a first opening for receiving the powder and a second opening for dispensing a dose of the powder;
a housing coupled with and located beneath the containing means and including a top portion with a dosage portal, wherein the dosage portal and the second opening of the containing means are vertically powder dispensing device misaligned;
dispensing means for receiving the dose of powder from the containing means through the second opening and for dispensing the dose of powder through the dosage portal of the housing; and
actuating means for moving the dispensing means between receiving the dose of powder from the containing means and dispensing the dose of powder through the dosage portal of the housing.

11. The powder dispensing device according to claim 10, further comprising agitation means for agitating powder held within the containing means.

12. The powder dispensing device according to claim 11, wherein the agitation means comprises at least one shaped bar within the containing means.

13. The powder dispensing device according to claim 10, wherein the dispensing means includes a dosage chamber and is configured to move between a first position and a second position, the first position is configured to substantially align the dosage chamber with the second opening of the containing means, and the second position is configured to substantially align the dosage chamber with the dosage portal of the housing.

14. The powder dispensing device according to claim 10, wherein the dispensing means includes a dosage chamber and is configured to move between a first position and a second position, the first position is configured to substantially align the dosage chamber with the second opening of the containing means, and the second position is configured to substantially align the dosage chamber with the dosage portal of the housing.

15. The powder dispensing device according to claim 10, wherein the housing further comprises a bleed hole within the top portion, wherein the bleed hole is substantially vertically aligned with the second opening of the containing means.

16. The powder dispensing device according to claim 10, wherein the dispensing means includes an dosage chamber, wherein the volume of the dosage chamber is adjustable.

17. The powder dispensing device according to claim 16, wherein at least one wall of the dosage chamber is moveable and the wall is coupled with a screw device for moving the wall.

18. The powder dispensing device according to claim 10, wherein the containing means comprises a gravity bin with funnel shaped walls.

19. The powder dispensing device according to claim 10, wherein the containing means comprises a gravity bin with funnel shaped walls.

20. The powder dispensing device according to claim 10, wherein the dispensing means comprises a slider that includes a top surface, a bottom surface, and a dosage chamber with an opening in both the top surface and the bottom surface, wherein the slider is configured to move between a first position and a second position, wherein in the first position the dosage chamber is substantially aligned with the dosage portal of the housing and in the second position the dosage chamber is substantially aligned with the second opening of the containing means.

21. The powder dispensing device according to claim 10, wherein portions of the powder dispenser comprise bisphenol A (BPA) free plastic.

22. The powder dispensing device according to claim 10, wherein portions of the powder dispenser comprise bisphenol A (BPA) free plastic.

23. A powder dispensing device comprising:
a funnel shaped gravity bin including a top opening and a bottom opening, and configured to contain powder, wherein the top opening is larger than the bottom opening;
a housing coupled with and located beneath the gravity bin and including a top portion with a dosage portal, wherein the dosage portal and the bottom opening of the gravity bin are substantially vertically misaligned;
a slider including a top surface, a bottom surface, and a dosage chamber with an opening in both the top surface and the bottom surface, wherein the slider is configured to move between a first position and a second position, wherein in the first position the dosage chamber is substantially aligned with the dosage portal of the housing and in the second position the dosage chamber is substantially aligned with the bottom opening of the gravity bin;
a powder agitator within the gravity bin; and
a manual lever that moves the slider between the first position and the second position when the lever is moved from a first lever point to a second lever point.
